(19) United States
(12) Patent Application Publication
(10) Pub. No.: US 2026/0339980 A1
(43) Pub. Date: Oct. 29, 2026

(54) SYSTEM AND METHOD FOR OPTIMIZING TENANT ALLOCATION

(71) Applicant: SAP SE, Walldorf (DE)

(72) Inventors: Sudhir PADAKAL, Plano, TX (US); Gokul NAIDU, Frisco, TX (US)

(21) Appl. No.: 19/188,718

(22) Filed: Apr. 24, 2025

(51) Int. Cl. G06F 16/28; G06F 8/65; G06F 9/50

(52) U.S. Cl. CPC G06F 16/285; G06F 8/65; G06F 9/5083

(57) ABSTRACT

According to some embodiments, systems and methods are provided including receiving application data for an application executed by one or more tenants; generating an application module complexity value based on the received application data; identifying one of one or more multi-tenant database clusters as a target environment for a first tenant based on the application module complexity value, wherein the application module complexity value is based on a number of application modules configured for the identified first tenant, a number of application interfaces, and a number of nested operations; and automatically locating at least the first tenant to the target environment. Numerous other aspects are provided.

### BACKGROUND

An enterprise may utilize a cloud computing environment to let users perform tasks. For example, the enterprise may let various users execute an application via the cloud computing environment to process purchase orders, adjust human resources information, generate invoices, etc. With the advent of cloud technologies and the benefits of usage-based pricing for cost-effectiveness, organizations are rapidly transitioning workloads to such cloud infrastructures. Cloud infrastructure providers (and container orchestration technologies, including but not limited to, Kubernetes®, Amazon ECS®, Azure Container Instances (ACI)®, etc.) offer tooling and orchestration for compute resource offerings in their technology catalogs. Compute resources refer to computational resources, and are the hardware and software that process data and run applications; they can be physical or virtual.

Although cloud services offer real-world benefits, the services provided by these cloud services may be associated with a substantial cost for physical resources (e.g., data centers including compute units, storage devices, network bandwidth, etc.). Data centers are physical facilities that house servers, storage systems, network equipment and other hardware to provide cloud and other computing services. Further, these cloud services (e.g., database, application, etc.) may suffer from an under-utilization of resources. For example, physical resources may not be utilized to their highest potential as a result of miscalculated usage forecasts and/or the elastic scaling of resources. The miscalculation may be due, in part, to reliance on generic host-level metrics (e.g., CPU usage, memory usage, I/O usage). This over-provisioning may also increase the cost of the infrastructure and lead to increased energy consumption and carbon emissions.

Conventionally, organization-reported resource consumption metrics like Central Processing Unit (CPU) usage, memory usage and response time may be used to directly allocate resources. However, these metrics may not accurately describe resource consumption. For example, utilization metrics do not capture a machine that is waiting for some process to complete, as the machine is not active.

Systems and methods for improvement in processes related to the allocation of resources would be desirable.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates multi-tenant, single-server database usage.

FIG. 2 illustrates multi-tenant, multi-server database usage.

FIG. 3 is a high-level block diagram of a system architecture according to some embodiments.

FIG. 4 is a flow diagram of a process according to some embodiments.

FIG. 5 is a flow diagram of a process according to some embodiments.

FIG. 6 is a flow diagram of a process according to some embodiments.

FIG. 7 is a block diagram of the tenant relocation engine according to some embodiments.

FIG. 8 illustrates a tenant management display according to some embodiments.

FIG. 9 is a block diagram of a hardware environment according to some embodiments.

FIG. 10 illustrates a table computer according to some embodiments.

Throughout the drawings and the detailed description, unless otherwise described, the same drawing reference numerals will be understood to refer to the same elements, features and structures. The relative size and depiction of these elements may be exaggerated or adjusted for clarity, illustration and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein. It should be appreciated that in development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

One or more embodiments or elements thereof can be implemented in the form of a computer program product including a non-transitory computer readable storage medium with computer usable program code for performing the method steps indicated herein. Furthermore, one or more embodiments or elements thereof can be implemented in the form of a system (or apparatus) including a memory, and at least one processor that is coupled to the memory and operative to perform exemplary method steps. Yet further, in another aspect, one or more embodiments or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

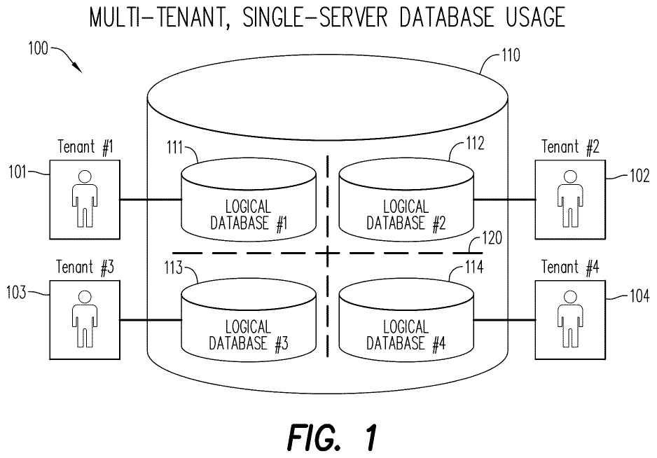

FIG. 1 illustrates 100 multi-tenant, single-server database usage. Multi-tenant database architecture allows multiple tenants (e.g., customers/users, applications/workloads) to share a single database instance while maintaining logical data isolation. This setup may be referred to as multi-tenant database containers (MDC). All of the tenants in the MDC share the same installation of the database system software and the same computing resources.

Here, four tenants 101, 102, 103 and 104 (tenant #1 through tenant #4) access logical databases 111, 112, 113 and 114 in database instance 110 (e.g., tenant #1 accesses logical database #1 111, etc.). The logical databases 111, 112, 113 and 114 are separated from each other via database boundaries 120 (illustrated by a dashed line in FIG. 1). A multi-tenant server is a dedicated installation of a database engine, which is owned by a software provider and shared among multiple consumers of the software. The provider application designates one logical database 111, 112, 113, 114 per consumer (e.g., per tenant 101, 102, 103, 104) and connects to the consumer-specific database based on operations requested by the consumer. Ownership and management of the server is still the responsibility of the software provider. That is, aspects related to scaling, quotas, resource management, etc. may be handled by the software provider.

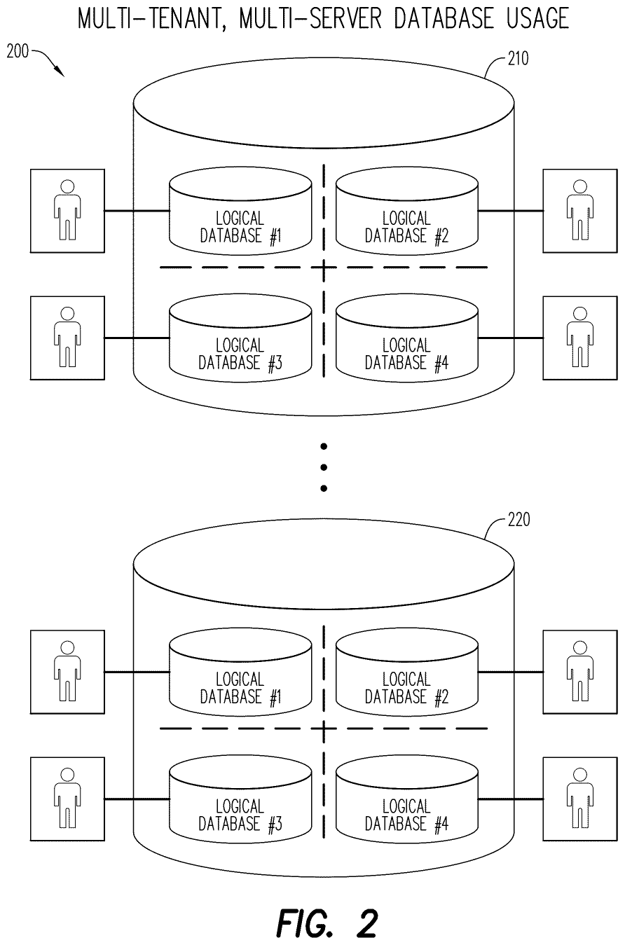

FIG. 2 illustrates 200 multi-tenant, multi-server database usage. In this example, multiple database instances 210, 220 have logical databases that are accessed by tenants. Multiple applications connect to a logical database of its own. The database system provider may be responsible for the orchestration of the physical servers and an allocation of logical databases (within the available resource limits of the servers). In some cases, the eight tenants shown herein access the two shown database instances 210 and 220, with four tenants accessing database instance 210 and the other four tenants accessing database instance 220. It is noted that a multi-tenant, multi-server cloud system may include more (or less) than eight tenants and more than two database instances, as well as tenants accessing more than one database instance. For example, in other cases, the same four tenants in FIG. 2 accessing database instance 210 also access database instance 220.

As described above, it is desirable in cloud computing to allocate the compute resources (“resources”) such that the resources are not underutilized (e.g., more resources are allocated than needed) and are not overutilized (e.g., too few resources are allocated, resulting in delays in obtaining data). Traditional multi-tenant database architectures often rely on host-level metrics (e.g., CPU utilization, memory utilization, number of inputs/outputs) for resource provisioning and scaling. As a non-exhaustive example, in a case a customer is complaining about response time, traditionally, the tenant may be moved to another MDC. However, this approach fails to consider why this tenant is behaving differently compared to other tenants, and in particular fails to consider application-specific functional and non-functional performance and scalability requirements. Failure to account for this performance discrepancy and associated requirements may lead to resource contention, performance bottlenecks, over-provisioning and inefficient scaling. With respect to resource contention, tenants with high resource demands may impact the performance of others sharing the same infrastructure. With performance bottlenecks, inefficient resource allocation may create bottlenecks, degrading overall system responsiveness. With over-provisioning, to mitigate performance issues, resources are often over-provisioned, leading to increased costs and wasted resources. With inefficient scaling, reacting to performance issues reactively may result in slow and inefficient scaling, impacting application availability.

To address these problems, a tenant rebalancer framework or system provides for continuously monitoring tenant-specific and application-aware Key Performance Indicators (KPIs), analyzing real-time performance data, and automatically relocating existing tenants and locating/assigning new tenants to optimize resource utilization and maintain desired performance levels. The tenant rebalancer framework provides for dynamic tenant optimization in multi-tenant database environments. Embodiments provide for receiving one or more application metrics and analyzing those metrics based on predefined parameters. Then, different groups of resources are analyzed to determine their resource availability. A relocation strategy next determines a target environment having optimal available resources for relocating the tenant. Finally, the tenant is automatically relocated to the target environment. Embodiments further provide for receiving metrics for an application to be used by a new tenant, analyzing different groups of resources to determine their resource availability, determining-via a location strategy-the target environment having optimal available resources for allocating the new tenant, and automatically allocating the new tenant to the target environment. By leveraging one or more of: application-aware KPIs, real-time performance data analysis, and automatic relocation/allocation (location) mechanisms, embodiments achieve superior performance, scalability, cost-efficiency, and availability compared to conventional approaches.

Embodiments provide for proactive performance management, whereby the framework anticipates potential bottlenecks by proactively monitoring application-specific KPIs, and enabling proactive tenant relocation/rebalancing before performance degradation occurs. Additionally, embodiments provide for optimized resource utilization. For example, dynamically adjusting tenant placement based on real-time workload demands ensures efficient resource allocation, preventing under-utilization/over-provisioning with respect to memory, CPU cores, storage, number of transactions and the duration of the transaction, for example. One or more embodiments provide for improved application performance. In particular, placing tenants (new and existing) in optimal environments based on their performance characteristics minimizes response times, maximizes throughput, and ensures a consistently high-quality user experience. Embodiments provide for reduced cost as efficiency resource utilization and avoidance of over-provisioning contribute to significant cost savings on infrastructure and operational expenses. Further, embodiments provide for enhanced scalability. For example, the system facilitates seamless horizontal scaling by dynamically redistributing tenants across available resources, accommodating workload fluctuations and business growth. Additionally, embodiments provide for increased availability. In particular, minimizing downtime during tenant migrations through real-time data replication and streamlined application reconfiguration enhances application availability and minimizes organization disruption. One or more embodiments provide for improved tenant isolation, as relocating tenants based on resource consumption patterns improves isolation between tenants, preventing noisy neighbor effects and ensuring consistent performance.

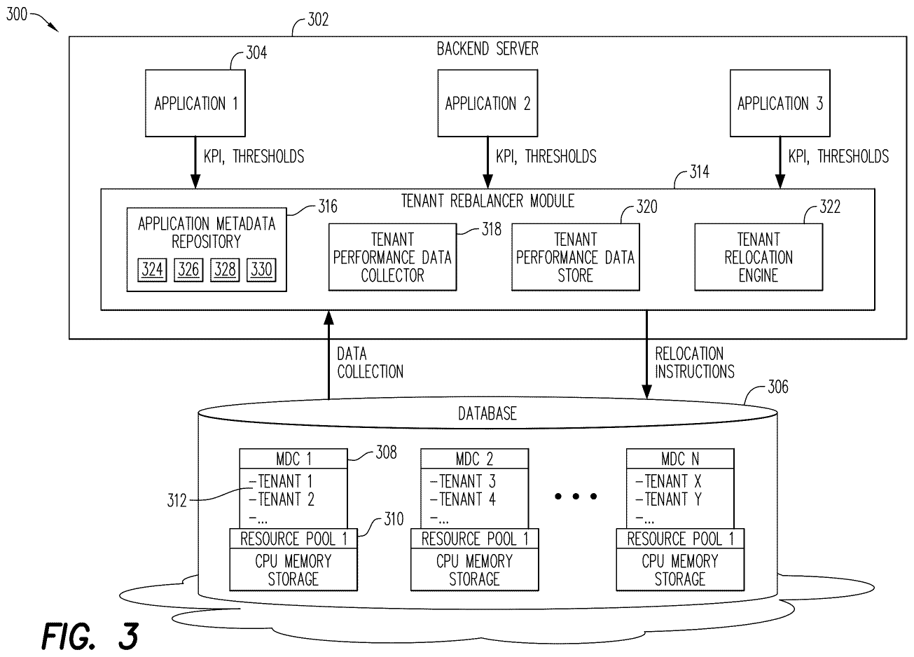

FIG. 3 is a high-level block diagram of a tenant rebalancer framework or system architecture 300 according to some embodiments. Embodiments are not limited to architecture 300.

The illustrated elements of system architecture 300 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. One or more elements of system architecture 300 may be implemented using any suitable combination of on-premise, cloud-based, distributed (e.g., including distributed storage and/or compute nodes) computing hardware and/or software that is or becomes known. Each computing system described herein may comprise one or more physical and/or virtualized servers.

In some embodiments, two or more elements of system architecture 300 are implemented by a single computing device, and/or two or more elements of system architecture 300 are co-located. One or more components may be implemented as a cloud service (e.g., Software-as-a-Service, Platform-as-a-Service). A cloud-based implementation of any element of FIG. 3 may apportion computing resources elastically according to demand, need, price and/or any other metric.

Backend server 302 may comprise one or more servers, virtual machines, etc. Backend server 302 may provide an operating system, services, I/O, storage, libraries, frameworks, etc. to applications executing thereon.

One or more application modules 304 (Application 1, Application 2, . . . Application N) on backend server 302 may comprise program code stored in a first memory and executable by a processing unit (e.g., processing environment) to provide functions to users based on coded logic and on data stored in data store 306. The system 300 may include multiple applications, and each application may include one or more application modules 304. As a non-exhaustive example, an application may have a payroll module, a finance module, a supply chain module, employee module, etc. Each tenant has the same application installed by default. However, the activity for the tenant depends on which modules the tenant has enabled/licensed. For example, the tenant may only enable the finance module or the supply chain module. The processing unit (e.g., processing environment) executes the program code for each application module for a respective tenant, and collects application data regarding execution of each application module for the tenant. In particular, each application module 304 defines specific Key Performance Indicators (K PIs) and thresholds relevant to its performance requirements. Each application module also monitors the custom KPIs tailored to it and tenant requirements, capturing granular performance indicators beyond generic host-level metrics. Non-exhaustive examples of K PIs are application specific behavior including number of modules enabled for the tenant, module behavior (e.g., locking, application throughput), and application-specific complexity; usage pattern/user seasonality; number of active users; unit of work such as throughput (i.e., number of transactions/requests processed per unit time; measures application capacity), number of transactions, length of transaction, time required to process a transaction; CPU utilization, memory and storage utilization, logical and physical input/outputs; average and percentile and max response time of a transaction for a module; external service calls (e.g., monitor calls to Application Programming Interfaces (A Pls), message queues, etc., including their latency and error rates); relative usage and ranking of the tenant in comparison to others within the container; Lifetime Value (LTV) of customer tenant; relative importance of a customer based on segmentation or industry; availability requirement; scalability requirement and security and compliance.

Data may comprise tabular data stored in a columnar or row-based format, object data or any other type of data that is or becomes known. Data store 306 may comprise any suitable storage system such as a database system, which may be partially or fully remote from backend server 302, and may be distributed as is known in the art. Data store 306 includes one or more multi-tenant database containers (or clusters) (MDCs) 308. In one or more embodiments, the system 300 may include one system database for central system administration and additional MDCs which may be referred to as tenant databases. While the MDCs 308 may share the same system resources (e.g., resource pool #1 310 including memory, Central Processing Unit (CPU) cores and storage), each MDC is self-contained and has its own database users 312 (e.g., tenant X, tenant Y, etc.), database catalog, repository backups and logs. Each MDC hosts several tenants. As used herein, tenants may refer to individual users and/or applications. Pursuant to embodiments, the system 300 dynamically allocates tenants across MDCs based on resource availability and performance requirements. Each resource pool 310 illustrates a logical grouping of resources (CPU cores, memory, storage) within each MDC 308, providing flexibility in resource allocation and isolation.

The tenant rebalancer module 314 may comprise program code stored in a second memory for tenant relocation/allocation and executable by backend server 302 to operate as described herein. The tenant rebalancer module 314 includes an application metadata repository 316, a tenant performance data collector 318, a tenant performance data store 320 and a tenant relocation engine 322.

The application metadata repository 316 stores information (e.g., application-specific configurations) for each application module 304, including custom KPI definitions 324, KPI thresholds 326, relocation rules 328, and tenant priority information (tenant metadata 330). The application metadata repository 316 receives KPI and threshold configuration data from application modules. Application module-specific KPIs define granular performance metrics tailored to each application module. Non-exhaustive examples of application module-specific KPIs are database-level KPIs, application-level KPIs, and business-level KPIs. The application-specific KPI definitions 324 include, but are not limited to, table size and growth rate, index usage, lock contention, query execution time, and deadlocks. The application-level KPIs include, but are not limited to, transaction throughput, response time for specific operations, error rates, and user concurrency. The business-level KPIs include, but are not limited to, order processing time, customer conversion rates, and revenue per tenant. KPI thresholds 326 specify the acceptable range for each KPI. The tenant relocation engine 322 triggers actions when the KPI threshold 326 is breached. KPI thresholds may be static or dynamically adjusted based on historical data and learning algorithms. The relocation rules 328 define the logic for tenant relocation based on violated KPI thresholds, tenant priority, resource availability in target environments, and cost considerations. Tenant metadata 330 stores information about each tenant, including their service level agreements (SLAs), resource entitlements and contact information.

The tenant performance data collector 318 actively and continuously gathers real-time performance data from active database tenants based on defined KPIs in the application metadata repository 316, interacting directly with database instances for individual tenants 312. In one or more embodiments, each database instance has an individual monitoring tool (e.g., agent) running thereon, that collects real-time performance data. The performance data may be time-series data. In particular, the individual monitoring tools collect data via at least one of database monitoring and application instrumentation. With database monitoring, performance metrics are pulled via query from tenant specific application tables from each database instance. With application instrumentation, the data collection is integrated with application code included in the application module itself to capture application-level performance data, including, but not limited to, transaction response times and business process metrics.

Tenant performance data store 320 is a time-series database optimized for storing and analyzing time-stamped tenant performance data collected by the tenant performance data collector 318, providing historical and real-time insights into tenant behavior. The data from the tenant performance data collector 318 is transmitted securely to the tenant performance data store 320. The tenant performance data store 320 provides for high-volume data ingestion, efficiently ingesting large volumes of time-stamped performance data from multiple tenants. The tenant performance data store 320 provides for fast data retrieval, with low-latency data retrieval for real-time analysis and historical reporting. The tenant performance data store 320 provides for efficient data aggregation and analysis of performance data over different time periods and dimensions.

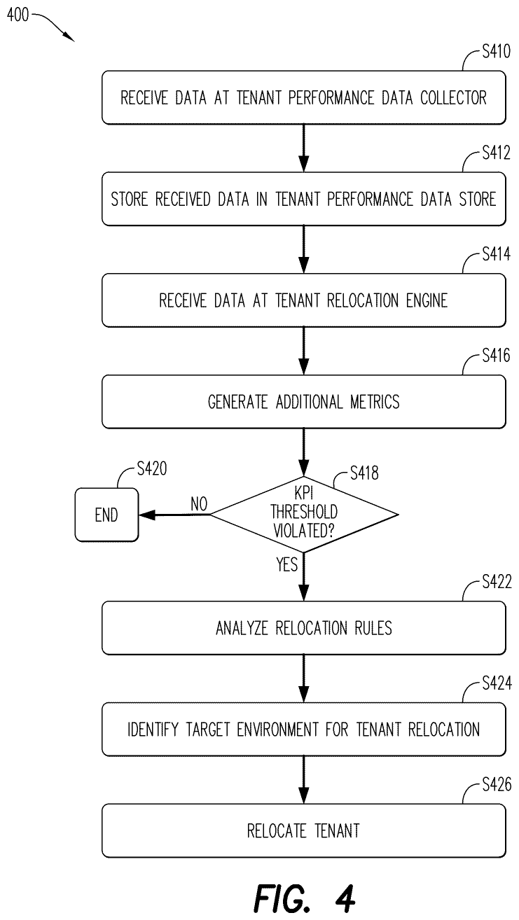

The tenant relocation engine 322 continuously analyzes the performance data collected by the tenant performance data collector 318, identifying patterns, trends and anomalies. Additionally, the tenant relocation engine 322 evaluates the data with respect to the thresholds by comparing the real-time performance data against the predefined KPI thresholds stored in the application metadata repository 316. The tenant relocation engine 322 automatically triggers alerts transmittable to remote devices (not shown) and actions (e.g., automatically relocating a tenant) upon threshold violation. The tenant relocation engine 322 determines a tenant is eligible for relocation upon violation of the threshold. The tenant relocation engine 322 then determines an appropriate relocation strategy. In particular, based on the analyzed data, thresholds, relocation rules, and resource availability, the tenant relocation engine 322 determines the optimal target environment for tenant relocation. The determination is based on at least one of: performance impact minimization and resource balancing. Performance impact minimization includes selecting target environments that minimize performance impact on other tenants. Resource balancing includes distributing tenants evenly across resources to avoid hotspots and optimize utilization. The tenant relocation engine 322 also executes the relocation by triggering and coordinating the tenant relocation process via communicating instructions with the database infrastructure (e.g., database instances 306) and application-modules 304, described further below with respect to FIGS. 4, 5 and 6.

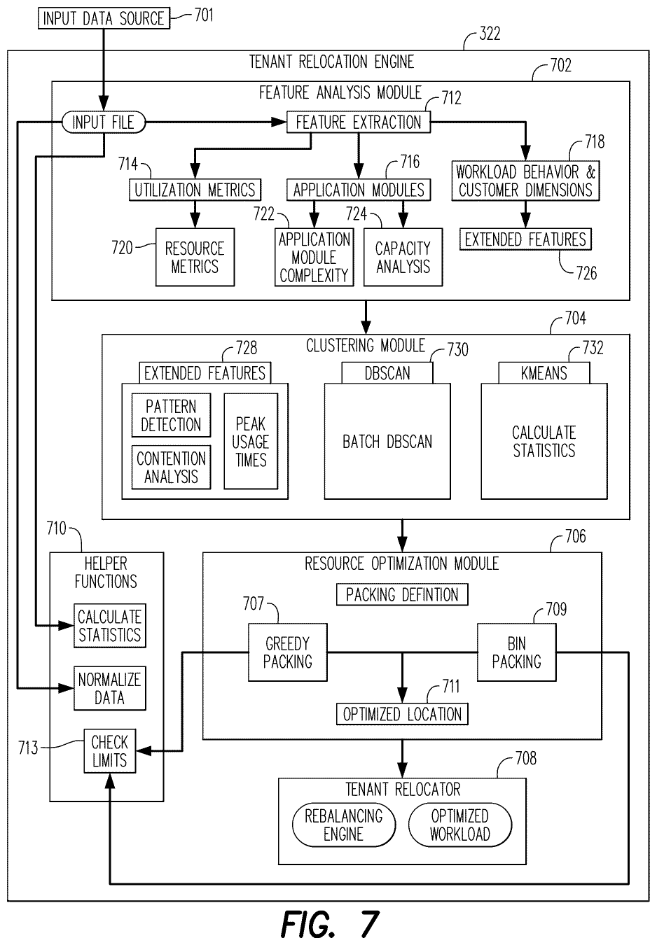

FIGS. 4, 5 and 6 illustrate processes 400, 500, 600, respectively, that may be performed by some or all of the elements of the system architecture 300 and relocation engine 322, described with respect to FIGS. 3 and 7, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

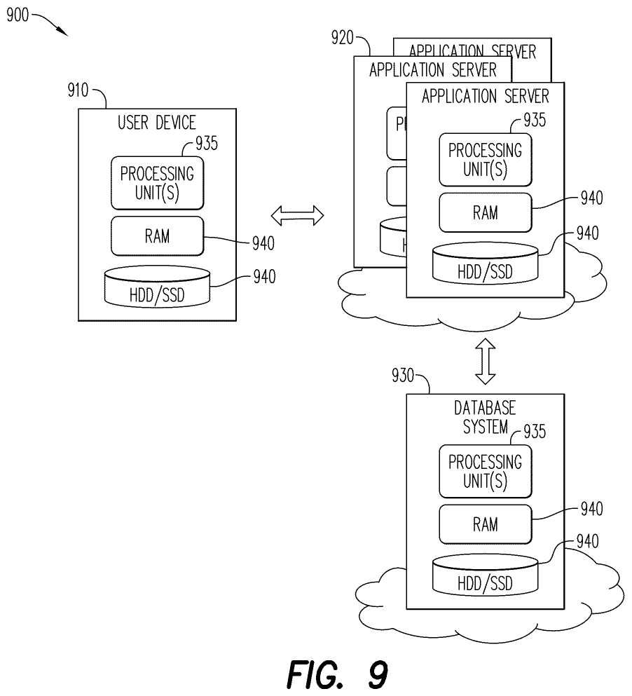

The processes 400/500/600, and other processes described herein, may be performed by a database node, a cloud platform, a server, a computing system (user device), a combination of devices/nodes, or the like, according to some embodiments. In one or more embodiments, the system architecture 300 (including relocation engine 322) may be conditioned to perform the processes 400/500/600, and other processes described herein, such that a processing unit 935 (FIG. 9) of the system architecture 300 is a special purpose element configured to perform operations not performable by a general-purpose computer or device.

All processes mentioned herein may be executed by various hardware elements and/or embodied in processor-executable program code read from one or more of non-transitory computer-readable media, such as a hard drive, a floppy disk, a CD-ROM, a DVD-ROM, a Flash drive, Flash memory, a magnetic tape, and solid state Random Access Memory (RAM) or Read Only Memory (ROM) storage units, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S410, data is received for one or more tenants 312, the data regarding execution of the application. The data may be real-time performance data and may be received by the tenant performance data collector 318 from each tenant based on the defined KPIs in the application metadata repository 316. As described above, the data may be pulled from tenant specific application tables from each database instance in response to a query. Additionally, the data may be captured via code integrated into the application itself. The received data may be stored in the tenant performance data store 320 at S412.

At S414, the tenant relocation engine 322 receives application data including at least one of application utilization metrics, application module data, and application workload behavior and customer dimension data. The tenant relocation engine 322 receives data directly from the tenant performance data collector 318 and from the data store 306 (“database infrastructure”). It is noted that S412 and S414 may occur at the same time, or substantially the same time, or in sequential order, or reverse order. With respect to the data received from the data store 306, the data includes a resource availability assessment data. The resource availability assessment data is received in response to a query from the tenant relocation engine 322 to the data store 306, and the resource availability data includes resource utilization levels in different MDCs and their associated resource pools 310. When compared to allotted levels, the resource availability data indicates an amount of available resources.

Then at S416, the tenant relocation engine 322 generates additional metrics from the received data, as described further below. The generated metrics include, but are not limited to, an application module complexity value 722 (FIG. 7). The application module complexity value describes the custom or proprietary behavior of application modules and their dependencies. The application module complexity value 722 is defined by the number of modules configured for the tenant and custom functionalities defined in those modules; the number of interfaces (internal and external); nested operations; and the granular control of resources and limits at the application module layer, measured in terms of concurrency (shared resources between two or more application modules) and time limits associated with the number of application modules. A first non-exhaustive example of the number of modules is an application module that determines pay increase and allows up to 15 custom business rules, and a particular tenant may only have 8 of the custom 15 business rules. A second non-exhaustive example of the number of modules is an application that allows encrypting Personally Identifiable Information (PII) data, which only a few tenants have enabled as encryption/decryption, and consumes additional resources and involves other processes such as Key Lifecycle Management. With respect to the number of interfaces (internal and external), this is measured in terms of external and internal system dependencies. The more external interfaces, the more latency. Non-exhaustive examples with respect to dependencies are a module waiting for data from an external entity (e.g., an API call that is dependent upon another system), a module depending on post processing on one or more objects, etc. With respect to nested operations, one module calls another module's functionalities in a sequential or parallel manner that are proprietary in nature. This may be measured in the number of nested operations that are performed locally and in remote systems. Non-exhaustive examples with respect to the number of operations is the number of records to be processed in a batch process (e.g., row-by-row processing, set-based processing, etc.). The application module complexity value 722 is generated based on the received data and data stored in the application metadata repository 316. Based on this data, a pre-application module complexity value may be assigned, then normalized, and then a weighted average is applied. After application of the weighted average, the value is the application module complexity value 722. As a non-exhaustive example, an application has ten modules, and based on the application configuration, the order of priority of execution of the modules is known (e.g., dependencies), how operationally relevant the modules are (e.g., number of operations) is known, and how critical the modules are is known. Based on this information, the application module complexity value 722 is generated. With two modules enabled, the system becomes more complex because the system is communicating with n number (e.g., 10) other modules. For example, the tenant may have payroll, finance and supply chain application modules enabled. The payroll module is constantly communicating with the finance module, and the finance module is communicating with the supply chain module; and the supply chain module is communicating with external vendors. As such, the complexity of having multiple modules enabled is much higher than for having a single module enabled.

It is noted that with one module enabled, the result is X amount of load factor or response time. Load factor refers to the ratio of the average load to the peak load; and load refers to number of users accessing (or requests received by) the system simultaneously. A high load factor (close to 100%) means the system is operating near its capacity, potentially leading to slower response times, while a low load factor (below 50%) means the system is underutilized, with ample capacity to handle requests quickly.

In S418, the tenant relocation engine 322 determines, for each tenant, whether a threshold has been violated for each application module specific KPI. The tenant relocation engine 322 compares, for each tenant, the received data and the generated additional metrics to KPI thresholds 326 stored in the application metadata repository 316 with respect to the resource availability assessment. The tenant relocation engine 322 may compare individual time stamp data to the KPI thresholds 326 or may compare an average (e.g., median, mode, or other measure) of the time stamp data for a given period of time to the KPI thresholds 326.

In a case the KPI threshold 326 is not violated, the process 400 ends at S420. In a case the KPI threshold 326 is violated, the tenant is identified as a relocation candidate and the tenant relocation engine 322 analyzes the breached KPI threshold 326 with respect to the relocation rules 328 in S422. As described above, the relocation rules 328 define the logic for tenant relocation based on violated KPI thresholds 326, tenant priority, resource availability in target environments per resource pools 310, and cost considerations.

Then, in a case the relocation rules 328 indicate tenant relocation, the tenant relocation engine 322 identifies a target environment for relocation of the tenant to in S424 using the resource availability assessment. The target environment is one of one or more MDCs 308. The target environment includes a resource pool to accommodate the tenant candidate. As described above, the determination of a target environment is based on at least one of: performance impact minimization and resource balancing, such that the target environment has under-utilized resources.

After the target environment has been identified, the tenant is automatically relocated to the identified target environment in S426, and the program code for the application module(s) is then executed for the relocated tenant on the identified target environment.

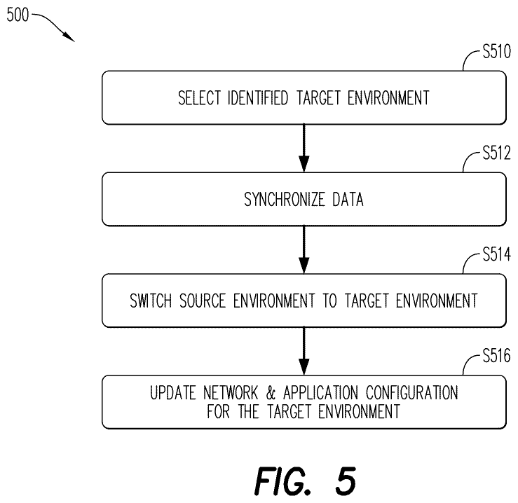

The automatic relocation of the tenant 312 includes execution of a cutover relocation process 500 (FIG. 5) by the tenant relocation engine 322. During the cutover relocation process 500 data is continuously synchronized or copied from the source environment to the target environment. The synchronization may be through at least one of real-time data replication or periodic data transfers.

Initially, at S510 the identified target environment is selected. Then, at S512 the data is synchronized. In one or more embodiments, replication includes the establishment of real-time data replication between the source database instance (i.e., the database instance where the tenant is currently operating and where the KPI violation occurred) and the target database instance (i.e., selected target environment). The replication may be via database-native replication mechanisms or other suitable tools. During replication, the activity (write operations, insert operations, update operations) occurring at the source database instance is replicated in real-time at the target database instance. Also during replication, the delta data is synchronized. The synchronization captures and synchronizes data changes (delta data) occurring during the replication process to ensure data consistency. Depending on the chosen replication technology and application tolerance for downtime, a brief write freeze is executed on the source tenant whereby the source tenant no longer accepts write operations while the delta data is fully synchronized to the target environment. Then in S514 the source environment is switched to the target environment. The application modules need to be redirected/relocated to the target environment. However, the application module tenant traffic can only be redirected/relocated to the target environment when the data is in complete sync. During this switching process, neither the source environment nor the target environment is used. For example, for every period of time (e.g., 30 seconds), the activity at the source database instance is stopped (e.g., stop the tenant-specific application modules from receiving activity). Once the activity is stopped, all the activity since the application stop is copied in real time. Then an automated verification process ensures all of the activity is copied accurately such that both systems have the same data, minimizing data loss or inconsistencies during the transition. After the replicated data is verified, the tenant is shut down on the source database instance, and brought online in the target environment in a read/write mode until the replication process completes. Next, at S516 a Domain Name System (DNS) cutover process updates the DNS records as an application update with respect to the endpoints, Internet Protocol (IP) address and port number for the target environment as used by the application and tenant. The automatic relocation of the tenant to the target environment includes receipt at the tenant of the application update per the updated DNS records.

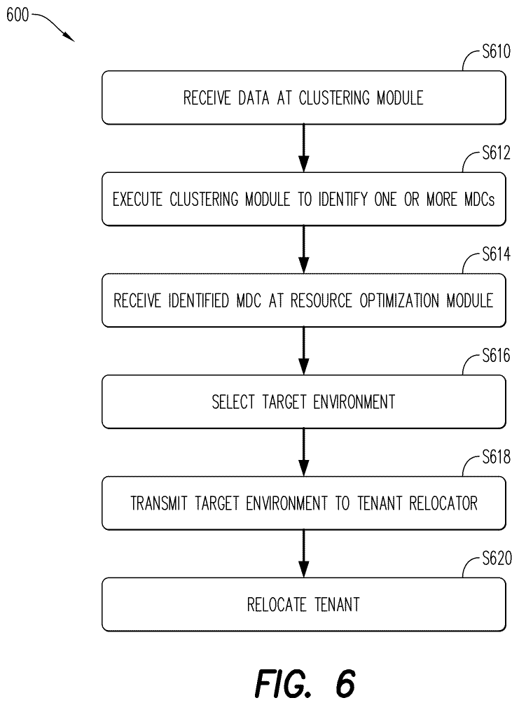

Turning to FIG. 6, a relocation process 600 executed by the tenant relocation engine 322 is provided.

FIG. 7 is a block diagram of the tenant relocation engine 322. The tenant relocation engine 322 includes a feature analysis module 702, a clustering module 704, a resource optimization module 706, a tenant relocator 708 and helper functions 710. The features of the tenant relocation engine 322 will be further described with respect to the relocation process 600 of FIG. 6.

Prior to the start of the process 600, the tenant rebalancer module 314 receives one or more application-specific KPIs and pre-defined threshold configuration data for each application specific KPI relevant to its performance requirements. Threshold configuration data defines the limits or ranges against which the tenant rebalancer module monitors the KPIs to trigger alerts or events when those KPI measures go outside of the defined thresholds. The thresholds are configured against the KPIs collected (or in some cases generated) by monitoring tools. As described above, these thresholds are stored in the application metadata repository 316.

As described above, with respect to S410 and S414 of FIG. 4, data is received for one or more tenants 312. The data may be received as an input file 701 (FIG. 7) by feature analysis module 702 of the tenant relocation engine 322 and from one or more monitoring tools of the tenant performance data collector 318. A feature extraction process 712 is executed by the feature analysis module 702 using the data from the input file 701. The feature extraction process 712 is a machine learning process that identifies and extracts relevant information (features) from the input file 701. The input file 701 may include time series data, and the feature extraction process 712 may extract trends and other patterns therefrom, transforming the data included in the input file 701 into a new set of transformed features. The extracted features include, but are not limited to, utilization metrics 714 (e.g., from the resource availability assessment), application module data 716 and workload behavior and customer dimensions data 718. The utilization metrics 714 include, but are not limited to, resource metrics 720 (e.g., CPU utilization, memory utilization, etc.) provided in response to a query from the tenant relocation engine 322 to the data store 306 to determine resource utilization levels in different MDCs and their associated resource pools. The application module data 716 is used to generate the application module complexity value 722 of the modules. The application module data 716 also includes, but is not limited to, application capacity analysis 724 and application-level performance data. The application module complexity value 722 is based on the number of modules in a given application that are enabled for a particular tenant and application-level performance data, such as transaction response times for each module and business process metric data. The workload behavior and customer dimensions data 718 includes, but is not limited to, extended features 726 (e.g., lifetime value (LTV) of a customer, the revenue that the customer provides, etc.).

Then, as in S418, it is determined the KPI threshold is violated for a given application module for a given tenant and the application rules are analyzed as in S422.

In S610, data is received at the clustering module 704.

As part of the application rules analysis for relocating a tenant, the data received by the clustering module 704 includes, but is not limited to, the application module complexity value 722, application capacity analysis 724, resource metrics 720 and extended features 726 from the feature analysis module 702.

The data received by the clustering module 704 may alternatively be data related to allocating/locating a new tenant to an MDC (as opposed to relocating an existing tenant that violates the KPI threshold). In this case, the data received by the clustering module 704 may include, but is not limited to, an application module complexity value based on the number of modules in a given application that are enabled for the new tenant, an application capacity analysis, and extended features.

The clustering module 704 is then executed in S612. While FIG. 7 includes the following clustering processes, a time series process 728, a Density-Based Spatial Clustering of Applications with Noise (DBSCAN) clustering process 730 and a KMeans clustering process 732, any suitable clustering process may be used. Pursuant to one or more embodiments, the clustering module 704 is executed each time a KPI threshold is violated, or in a case there is a request to provision resources to a new tenant. The output of execution of at least one of a time series process 728, a DBSCAN clustering process 730 and a KMeans clustering process 732 is the identification of one or more multi-tenant database clusters (MDC) 308.

With respect to the time series process 728, the clustering module 704 identifies patterns in the time series data, identifies peak-usage times, and identifies competition for access to shared resources via a contention analysis. With respect to the DBSCAN clustering process 730, this process is an unsupervised machine learning technique used to group similar data points together into clusters, revealing underlying patterns and structures within the data. In particular, in the DBSCAN clustering process 730, the clustering module 704 groups datapoints into clusters based on regions of high density separated by regions of low density. In some instances, the clustering module 704 processes the entire dataset at once (unlike incremental or streaming approaches) via a batch DBSCAN process, meaning the algorithm needs to have access to all the data points simultaneously to perform the clustering. The DBSCAN clustering process 730 identifies “core points” within dense regions. It then expands clusters from these core points, connecting them to other points within a specified distance (epsilon) and minimum number of points (minPts). Epsilon is the maximum distance between two points to be considered in the same neighborhood. MinPts is the minimum number of points required to form a dense region (a cluster). Points that are not part of any cluster are labeled as “noise” or outliers. With respect to the KMeans clustering process 732, it is an unsupervised machine learning algorithm used to group data points into clusters based on similarity, with the goal of minimizing the variance within each cluster. It works by iteratively assigning data points to the nearest cluster centroid and then recalculating the centroid based on the assigned points. In particular, the algorithm randomly selects k initial centroids (data points representing the center of each cluster); assigns each data point to the nearest centroid, forming clusters; recalculates the centroids as the mean of all points within their respective cluster; repeats the assignment and recalculation until the centroids no longer move significantly or a maximum number of iterations is reached.

The identification of one or more multi-tenant database clusters (MDC) 308 is received by the resource optimization module 706 in S614, and the resource optimization module 706 selects a target environment of the identified one or more MDCs in S616. Based on the analyzed data, thresholds, rules, and resource availability, the resource optimization module 706 determines an optimal target environment for tenant relocation in a case the KPI threshold is violated, and determines an optimal target environment for tenant allocation (location) in a case of a new tenant. In one or more embodiments, the resource optimization module 706 selects a target via performance impact minimization (e.g., selecting target environments that minimize performance impact on other tenants in that target environment). In one or more embodiments, the resource optimization module 706 selects a target by distributing tenants evenly across resources to avoid hotspots and optimize utilization.

Pursuant to embodiments, the resource optimization module 706 optimizes how the target environment is packed. Packing is a set of parameters that are defined for a target environment, and determines the limits as to how the target environment is configured. As a non-exhaustive example, if a tenant is already running a complex application module value 722, it may be undesirable to have another tenant with more complexities in the same virtual machine. The packing limits help define where the tenant should be placed in the target environment.

The resource optimization module 706 executes any suitable packing process, including but not limited to, at least one of a greedy packing optimization process 707 and bin packing optimization process 709, to output an optimized location (target environment) 711 for the tenant's relocation/allocation.

With respect to the greedy packing optimization process 707, the process 707 makes the best immediate choice without considering future consequences. For example, each tenant is assigned to a bin based on its size while attempting to fill the bins as efficiently as possible using as few bins as possible.

With respect to the bin packing optimization process 709, the process 709 finds the fewest bins that will accommodate the tenant with respect to resources. For example, given as many bins with a common capacity as necessary, find the fewest bins that will hold all the items. Here, the MDC (target environment) is the bin.

It is noted that both the greedy packing optimization process 707 and the bin packing optimization process 709 may access the check limit element 713 of the helper function 710.

The optimized location (target environment) 711 for the tenant's relocation is transmitted to the tenant relocator 708 in S618. The tenant relocator 708 relocates the tenant in S620 using rebalancing engine 322 and an optimized workload process as in S426 of FIG. 4. It is noted that in one instance, rebalancing moves the tenants within an existing set of virtual machines, and in another instance, a new virtual machine is created and rebalancing moves tenants to the new virtual machine.

In the case of the new tenant, the optimized location (target environment) 722 for the new tenant's location/re-location thereto (e.g., from a non-allocated location) is also transmitted to the tenant relocator 708. The tenant relocator 708 automatically allocates (locates) the new tenant to the target environment by updating the DNS records as an application update with respect to the endpoints, updating application metadata about the tenant location, as well as the connection information like IP addresses, port numbers and security groups for the target environment as used by the application and new tenant. The automatic allocation of the tenant to the target environment includes receipt at the tenant of the application update per the updated DNS records, as described above with respect to S516.

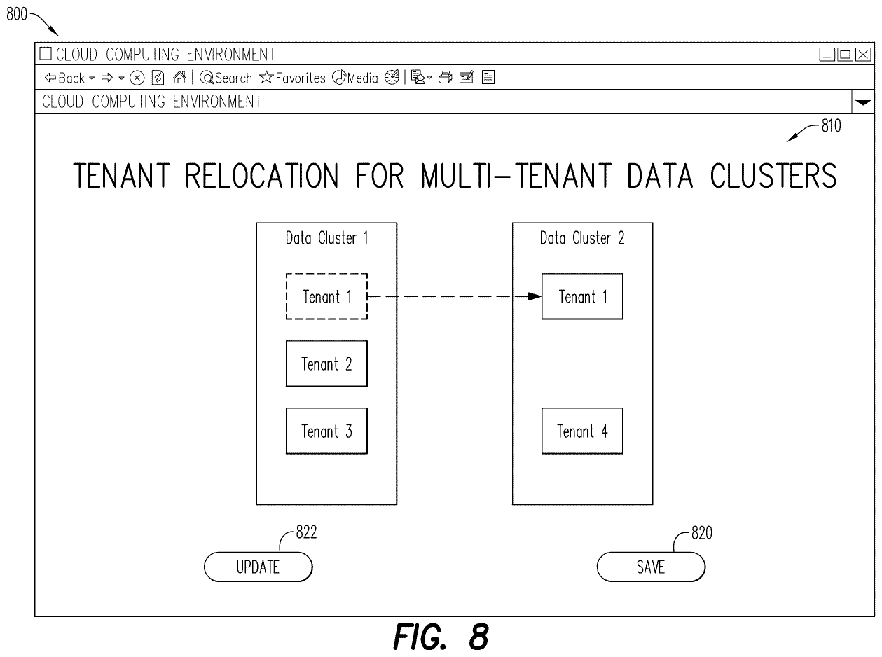

FIG. 8 is a tenant relocation display 800 according to some embodiments. The display 800 includes a graphical representation 810 or dashboard that may be used to manage the relocation of tenants across resources. In particular selection of an element (e.g., via a touchscreen or computer mouse pointer) may result in the display of a popup window that contains more detailed data. The display 800 also includes a user selectable “Save” icon 820 to store configurations and/or tenant mappings (e.g., from a source to a particular target environment) and an “Update” icon 822 to adjust values as appropriate.

Note that the embodiments described herein may be implemented using any number of different hardware configurations. For example, FIG. 9 illustrates a cloud-based hardware architecture 900 according to some embodiments. User device 910 may comprise a local computing system operated by a user to access functionality of an application executed by application server 920.

Application server 920 and database system 930 may comprise cloud-based resources residing in one or more public clouds providing self-service and immediate provisioning, autoscaling, security, compliance and identity management features. Application server 920 and database system 930 may comprise cloud-based compute resources, such as servers or virtual machines of suitable clusters, allocated by a public cloud provider, but embodiments are not limited thereto.

Each of user device 910, application server 920 and database system 930 may include a processing unit 935 that may include one or more processing devices each including one or more processing cores. In some examples, the processing unit 935 is a multicore processor or a plurality of multicore processors. Also, the processing unit 935 may be fixed or it may be reconfigurable. The processing unit 935 may control the components of any of the user device 910, application server 920 and database system 930. The storage device 940 may not be limited to a particular storage device and may include any known memory device such as RAM, ROM, hard disk, and the like, and may or may not be included within a database system, a cloud environment, a web server or the like. The storage device 940 may store software modules or other instructions/executable code which can be executed by the processing unit 935 to perform the method shown in FIGS. 4, 5, 6. According to various embodiments, the storage device 940 may include a data store having a plurality of tables, records, partitions and sub-partitions. The storage device 940 may be used to store database records, documents, entries, and the like.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, external drive, semiconductor memory such as read-only memory (ROM) , random-access memory (RAM) , and/or any other non-transitory transmitting and/or receiving medium such as the Internet, cloud storage, the Internet of Things (IOT), or other communication network or link. The article of manufacture containing the computer code may be made and/or used by executing the code directly from one medium, by copying the code from one medium to another medium, or by transmitting the code over a network.

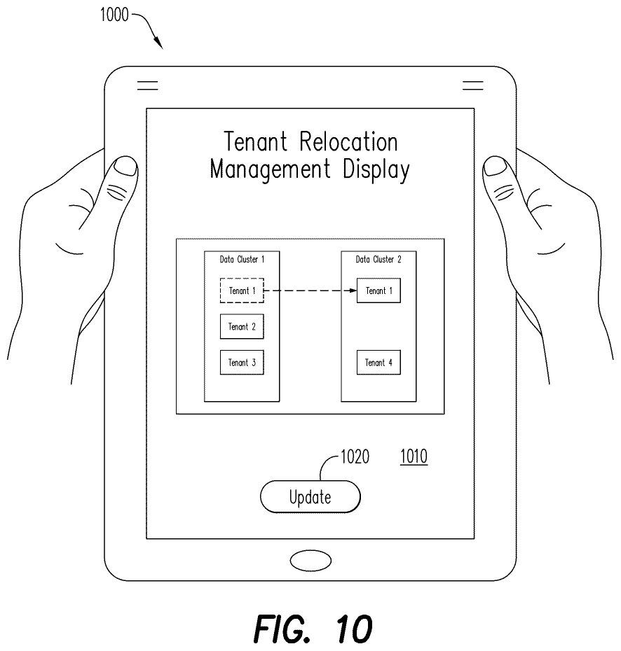

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor. Moreover, the displays shown herein are provided only as examples, and any other type of user interface could be implemented. For example, FIG. 10 illustrates a tablet computer 1000 providing a tenant relocation management display 1010 according to some embodiments. The display 1010 may be used, for example, to review tenant assigned locations, review reports, etc. Moreover, the display 1010 might be used to update and/or create tenant relocations, other parameters via an “update” icon 1020.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

1. A system comprising:
a first memory storing program code for at least one application;
a first processing unit executing the program code for the at least one application for a first tenant to cause the system to:
collect application data regarding the execution of the at least one application for the first tenant;
a second memory storing program code for tenant relocation; and
one or more processing units to execute the program code for tenant relocation to cause the system to:
receive the application data for the at least one application executed by the first tenant;
generate an application module complexity value based on the received application data;
identify the first tenant as a relocation candidate based on the generated application module complexity value exceeding at least one threshold;
identify a first multi-tenant database cluster having under-utilized resources as a target environment for the first tenant; and
automatically relocate the first tenant from a source environment to the target environment such that the program code for the at least one application is executed for the first tenant on the target environment.

2. The system of claim 1, further comprising the system to:
receive application data regarding execution of the at least one application by a second tenant;
generate the application module complexity value based on the received application data for the second tenant; and
determine the generated application module complexity value does not exceed at least one threshold.

3. The system of claim 1, wherein the under-utilized resources include at least one of memory, Central Processing Unit (CPU) cores and storage.

4. The system of claim 1, wherein the application includes one or more modules.

5. The system of claim 1, wherein the application module complexity value is based on a number of application modules configured for a given tenant, a number of application interfaces, and a number of nested operations.

6. The system of claim 5, wherein the application module complexity value is based on a number of shared resources between two or more application modules and time limits associated with the number of application modules.

7. The system of claim 1, further comprising a cluster module adapted to identify the first multi-tenant database cluster using the generated application module complexity value.

8. The system of claim 7, wherein the cluster module identifies the first cluster via execution of one of at least one of: a time series process, a Density-Based Spatial Clustering of Applications with Noise (DBSCAN) process, and a KMeans process.

9. The system of claim 1, wherein the identification of the target environment uses one of a greedy packing process and a bin packing process.

10. The system of claim 9, wherein both of the greedy packing process and the bin packing process use a packing limit in identifying the target environment.

11. The system of claim 1, wherein the received application data includes application utilization metrics, application module data, and application workload behavior and customer dimension data.

12. The system of claim 1, wherein the automatic relocation of the first tenant to the target environment further comprises:
receipt at the first tenant of an application update.

13. The system of claim 12, wherein the application update includes an Internet Protocol (IP) address and port number for the target environment.

14. A computer-implemented method comprising:
receiving application data for an application executable by one or more tenants;
generating an application module complexity value based on the received application data;
identifying one of one or more multi-tenant database clusters as a target environment for a first tenant based on the application module complexity value, wherein the application module complexity value is based on a number of application modules configured for the identified first tenant, a number of application interfaces, and a number of nested operations; and
automatically locating at least the first tenant to the target environment.

15. The method of claim 14, further comprising:
identifying the first tenant as a relocation candidate prior to identifying the target environment; and
wherein the automatic location of the first tenant to the target environment is a relocation from a source environment to the target environment.

16. The method of claim 14, wherein the first tenant is a new tenant and the automatic location is an allocation to the target environment.

17. The method of claim 14, wherein the application module complexity value is based on a number of shared resources between two or more application modules and time limits associated with the number of application modules.

18. The method of claim 14, wherein the identification of the target environment uses one of a greedy packing process and a bin packing process.

19. One or more non-transitory, computer-readable medium storing instructions, that, when executed by a computing system, cause the computing system to perform operations comprising:
receiving application data for an application executed by one or more tenants;
generating an application module complexity value based on the received application data;
identifying one of one or more multi-tenant database clusters as a target environment for a first tenant based on the application module complexity value, wherein the application module complexity value is based on a number of application modules configured for the identified first tenant, a number of application interfaces, and a number of nested operations; and
automatically locating at least the first tenant to the target environment.

20. The media of claim 19, wherein the automatic relocation of the first tenant to the target environment further comprises:
receiving an application update including an Internet Protocol (IP) address and port number for the target environment.
